(19) United States
(12) Patent Application Publication
(10) Pub. No.: US 2010/0228621 A1
(43) Pub. Date: Sep. 9, 2010

(54) Method of Using a Flat Panel Television to Deliver Digital Content to a Targeted Demographic

(76) Inventors: Howard Richard Hochhalter, Ellenton, FL (US); Sean Preston Thorp, Palm Harbor, FL (US); Mark Steven Carson, St. Petersburg, FL (US)

Correspondence Address: DOROTHY S. MORSE, 515 PARK DRIVE, NW, BRADENTON, FL, 34209, US

(21) Appl. No.: 12/539,613

(22) Filed: Aug. 12, 2009

Related U.S. Application Data
(63) Continuation-in-part of application No. 12/397,280, filed on Mar. 3, 2009.

(51) Int. Cl. G06Q 30/00; H04N 5/64

(52) U.S. Cl. 705/14.44; 348/794; 705/14.49; 705/14.61; 705/14.51; 348/E05.128

(57) ABSTRACT

A method of using a digital content display frame around a flat panel television that allows advertisers to use the attention-capturing power of television to reach a targeted demographic with content rich, high definition media in any location where a flat panel television is, or could be, located. Dynamic digital content is displayed on the centrally-located flat panel television, including plasma and LCD televisions, and/or on any combination of the display panels in the frame around it, which preferably comprises four panels in a rectangular configuration, but is not limited thereto. Digital content on any of the display panels can be independent or unified with any other panel, and/or the television. Content management of the displayed digital content can be remotely accomplished via one or more web interfaces, as well as locally via on-board USB, Cat5 wiring, firewire-type technology, and/or other means allowing quick upload of local content.

### CROSS-REFERENCES TO RELATED APPLICATIONS

This invention is a Continuation-In-Part of the U.S. utility patent application filed by two of the inventors herein on Mar. 3, 2009, and which was given the application number of and has the title of “Flat Panel Television Accessory Mounting Bracket and Enclosure”. Thus, since subject matter in the current patent application overlaps that in their previously filed U.S. utility patent application Ser. No. 12/397,280, the applicants herein request that domestic priority be established between the current U.S. utility patent application herein and their Ser. No. 12/397,280 application filed on Mar. 3, 2009.

### BACKGROUND

1. Field of the Invention

This invention relates to the fields of television, digital display panels, and methods of delivering digital content thereto, specifically to a method of using multiple secondary digital display panels or screens immediately around a flat panel television (including LCD and plasma televisions), and then employing the compelling attraction and attention-capturing power of television to allow advertisers of products and services to reach a targeted demographic with relevant, content rich, high definition media that can be seen in any location where a flat panel television is, or could be, located. Four secondary digital display panels/screens are preferably used and mounted via a thin cosmetic bezel and associated housing/frame (also referred to herein in combination as a digital content display frame assembly) to the centrally located television. Digital content can be displayed on the flat panel television, on the multiple secondary digital display screens or panels that are part of the frame assembly positioned for viewing immediately around the flat panel television, or on any combination thereof, with the frame assembly preferably containing four secondary digital display panels in a rectangular configuration, but is not limited thereto. The content of the digital media viewed on the secondary digital displays that are a part of the frame assembly is mostly dynamic, and can be in contrast to the digital content displayed on the centrally-located flat panel television, or the content of the digital media viewed on the secondary digital display panels that are a part of the frame assembly can be complementary to, unified with, and/or provide a seamless extension of, the digital content displayed on the centrally-located flat panel television. Furthermore, the content on the centrally-located flat panel television can change at the same speed as that on the secondary digital content display (DCD) panels that are a part of the frame assembly, or at a different rate than that on any of the secondary digital display panels that are a part of the frame assembly. Management of the digital content displayed on the flat panel television, as well as on the present invention secondary digital displays immediately surrounding it, can be remotely accomplished via one or more web interfaces, as well as locally accomplished via on-board USB, Cat5 wiring, firewire-type technology, or any other means allowing for fast upload of local content. The frame upon which the present invention secondary digital displays are mounted will house any required electronics needed to satisfy the power and communication requirements of the secondary digital displays, and may also be attached to an independent mounting system that is adaptable to more than one make and model of flat panel television. Once the present invention frame assembly is secured into its fixed position around a flat panel television, control cables are connected to the frame assembly to allow content rich, high definition media use. In other words, the present invention can be considered to be a dynamic message delivery system comprising a centrally-located television sign integrated with a frame having television-like media content display capability. Thus, the present invention dynamic television sign and dynamic television frame combination has built-in features allowing dynamic messaging, direct to any viewer thereof. The messaging or advertising can be optionally delivered via, but is not limited to, electronic digital screens, i.e. LED, LCD and/or similar or manually-changing graphic inserts, or delivered directly to sign and/or frame silk screening, among others. It is considered that any product attaching to a television or digital display screen so as to create a television sign and television frame combination for the purposes of dynamic message delivery or advertising falls within the scope of the present invention system or method disclosed herein. For purposes of this invention a television sign and television frame combination is defined as a device attached to the exterior of a television or digital display screen to change the appearance thereof without affecting the operation of the television or digital display screen, which after its installation provides the addition of secondary digital display panels and/or methods of dynamic message delivery (LED, LCD, graphic inserts, and the like) to the television sign and television frame combination to allow it to become an effective tool for marketing, advertising, and direct revenue generation. Applications may include, but are not limited to, use where content on the central television becomes slides, a movie, or a how-to-video loop; use at casinos, sporting events, shopping malls, airport terminals, and places where large groups of people congregate to attend a theme park, car show, or musical concert, to reach a targeted demographic with content rich, high definition media.

2. Description of the Related Art

Television screens have an almost unnatural ability to attract our attention, and no matter what their content consists of, we find ourselves looking at them, even if only briefly, and giving them our attention. Thus, they provide a desirable medium for broadcast of advertising media, but have mainly been used for such purposes in the home. With the recently experienced increased availability, popularity, and affordability of flat panel televisions, which can be mounted to a wide variety of wall and ceiling surfaces in commercial settings, current and new technologies relating to flat panel televisions now pave the way for a new and innovative way to provide advertising in a more focused way, as provided herein as a part of the present invention. Some of the technology facilitating the development and use of the invention system or method of delivering targeted dynamic advertising was created by the inventors herein and is the subject of an independent and currently pending U.S. patent application.

Several inventions are known that relate to advertising via dynamic video display means, and the use of multiple display panels is also known. However, the combination of their use in association with a flat panel television, so as to take advantage of the compelling attraction and attention-capturing power of television, is not known. U.S. Publication 20060150465 to Chen (2006), which is entitled “Display panel with three-dimensional effect” is an invention document that discloses an animated display device having multiple display panels positioned substantially coplanar with each other and at a distance from each other that allows the creation of a three dimensional effect of the images displayed on the first and second panels. According to one embodiment of the invention, the second panel includes an image that defines a frame through which an image on the first panel is visible or perceivable. The illustration in FIG. 1 of the Chen disclosure shows an image of a window with shutters opening away from the viewer, and a landscape beyond it. However, the Chen invention is different from the present invention as it does not suggest dynamic video displays associated with the overlaying panel, or a flat panel television associated with the rearward panel. Another invention document relating to multiple display screens and frames is U.S. Publication 20080007481 to another inventor Chen (2008), which is entitled “Digital photo frame having dual display panels”, where for the convenience of a viewer, one of the panels is oriented in a portrait mode and the other panel is oriented in a landscape mode. However, the Chen digital display panels are not arranged or configured to extend around the perimeter of a flat panel television, as in the present invention.

Several additional invention documents are known that show two or more display devices in close association with one another, and include U.S. Pat. No. 6,859,219 to Sall (2005) that discloses a computer with a primary display device, at least one secondary display device being operatively coupled to the primary display device for rotation or achieving independent angled orientation from that of the primary display device, and in addition at least one secondary display device is stored in a housing behind the primary display device, such that the at least one secondary display device can be extended from the housing and be used to display information for the computer. Although display devices above and to the side of a main computer screen are shown in the Sall illustrations, no display devices form a frame completely around the primary display device, also no television with its compelling attraction and attention-capturing power is used in the Sall invention, and furthermore the video displays in the Sall invention are not part of a digital display system integrated into a DCD frame assembly that turns the entire face of the frame around a centrally located flat panel television into a synchronous digital media canvas. This type of integrated frame structure found in the present invention is not disclosed in the Sall language, nor is it disclosed in U.S. Publication 20090153435 to Butler (2009) which shows a presentation system comprising a large main monitor connected to a personal computer, and four small satellite monitors connected to the main monitor that may display synchronous content with that displayed on the main monitor; nor is it disclosed in U.S. Publication 20090146911 to Kang (2009) which shows a dual-display presentation apparatus comprising a smaller display that is associated with a larger display in a manner that permits the smaller display to tilt and/or rotate relative to the larger display; nor in U.S. Publication 20090121969 to Stremlau (2009) which shows multiple display screens in alternative directions used for displaying identical information; not in U.S. Publication 20020021258 to Koenig (2002) which shows a portable wireless communication device comprising one central display screen and two additional screens foldably disposed to the right and left of the central screen; nor in U.S. Publication 200600242871 to Kondo (2006) which discloses a display device and method for composite image display, wherein televisions can be mounted side-by-side, above one another, or both, and may also be rotatable, in a manner that facilitates the viewing of more than one television at a time, and wherein the images on adjacent televisions are able to be viewed from positions 180-degrees from the other. Furthermore, although U.S. Pat. No. 7,561,116, to Westerinen (2009) discloses multiple displays within the same housing, such as three separate LCD panels that are placed in close proximity to one another so as to give the appearance of a single large display without incurring the cost of a large display screen, the Westerinen invention does not disclose multiple displays forming an integrated DCD frame assembly around a flat panel television in a way that would suggest the video display arrangement and use of the present invention DCD frame assembly.

Systems and methods used to provide advertising via dynamic video display means also generally relate to the present invention, except none were found to be exactly like the present invention. While U.S. Publication 20040227640 to Gothard (2004) shows a plasma display screen associated with a controller and modem, a remote computer having world wide web access associated with a transmitter and a modem, and broken lines showing a capability of sending ad copy via the remote computer via the modem or a satellite to the controller associated with the plasma display screen, no plasma display screen in the Gothard disclosure is shown associated with a DCD frame assembly having dynamic video display content, as in the present invention. Furthermore, U.S. Pat. No. 6,424,998 to Hunter (2002) in its claims 1 and 2 discloses a system permitting video or still image content to be displayed on selected ones of multiple electronic displays at selected times according to the dictates of system customers, said system comprising: a network connecting to a plurality of electronic displays; at least one central information processing station including: a customer interface permitting system customers to access the system; means permitting system customers to review options concerning their orders; means permitting a system customer to place an order for a particular video or still image content to be displayed on a particular electronic display of the network; means for transmitting customer-ordered video or still image content to the customer-selected electronic display location; and means for driving each electronic display to display customer-ordered video or still image content, with the system's electronic displays are located in outdoor or indoor high traffic areas primarily for advertising purposes. To target geographical regions and demographic groups with ever changing, current advertising content without incurring the high fixed cost of traditional single-message billboards, a customer of the Hunter system may access one of its central information processing stations via the Internet through a Customer Interface Web Server, which has a commerce engine and permits the customer to obtain and enter security code and billing code information into a Network Security Router/Access module. Alternatively, high usage customers of the Hunter system may utilize a customer interface comprising a high speed dedicated connection to the same module. Following access, the Hunter customer reviews options concerning his order by reviewing available advertising time/locations through a Review Schedule and Purchase Time module that permits the customer to see what time is available on any display throughout the world and thereafter schedule and purchase the desired advertising time slot. The Hunter customer then transmits the advertising content on-line through the Internet, a direct phone line or a high speed connection (for example, ISDN, or other suitable high speed information transfer line) for receipt by the Hunter Video & Still Image Review and Input module. Although overlapping subject matter exists between the Hunter invention and the present invention invention, the Hunter invention relates to ads displayed on billboards and in movie theaters, and does not use a flat panel television associated with secondary digital displays integrated into a DCD frame assembly that turns the entire face of the frame around the flat panel television into a synchronous digital media canvas, nor does it take advantage for advertising purposes of the compelling and attention-capturing power of television with its uncanny ability to attract our attention and hold it, even if only for a short duration of time.

Two additional U.S. Publications are known that appear to have the closest advertising subject matter to that in the present invention. However, both are distinguishable from the present invention. The first is U.S. Publication 20080303747 to Veliscescu (2008) and the second is U.S. Publication 20070069973 to Gerbacia (2007). The Veliscescu invention discloses improved capabilities for displaying and managing dynamic, multi-media, video content presentation on an architectural scale, with methods and systems including the association of video display content with an advertising marketplace and leasing rights to a video display. A provider of content to the Veliscescu invention may be an advertiser, and when a multi-panel video display is used, it may be coordinated across panels within the display to present a unified content that spans the multi-panel video display. Furthermore, in the Veliscescu invention a software editor is needed for managing the presentation of video display content. However, even though advertising and screen leasing rights are involved and associated with the displaying and managing of dynamic, multi-media, video content presentation, the title of the Veliscescu invention is METHODS AND SYSTEMS OF LARGE SCALE VIDEO DISPLAY, and the Veliscescu claims are directed to video display on a building facade (claim 10), a plurality of building facades (claim 11), an internal building feature (claim 12), a wall (claim 13), a gable (claim 14), a cornice (claim 15), a sign (claim 16), and a temporary architectural feature (claim 17), and there is no disclosure relating to the use of a flat panel television or secondary digital displays integrated into a DCD frame assembly that turns the entire face of the frame around the flat panel television into a synchronous digital media canvas, as in the present invention. However, the Gerbacia invention does disclose the use of flat panel televisions for advertising, and its abstract describes it as a network of modular video display stations controlled from one or more remote locations using commercially available or proprietary software, with each Gerbacia station containing a complete modular computer system and one or more display screens which can be arranged in many configurations. Each Gerbacia station is equipped with one or more cameras to provide visual data to the control centers, and the content of Gerbacia stations can be changed randomly and directed for viewing over a public network such as the Internet. Data in the Gerbacia invention is transmitted to and from its stations via wireless or wired commercial or proprietary networks. Displayed information can be presented in the Gerbacia invention with or without sound, and the volume can be controlled from a central location. Furthermore, Gerbacia stations can be fitted with various other devices, such as printers or microphones, and can contain dispensers for preprinted information. In addition, the Gerbacia illustrations show some of the various configurations contemplated for its remotely controlled modular video display stations, with FIG. 10A showing a wall-mounted unit; FIG. 10B showing a single display station mounted on a pedestal; 10C showing a computer module installed in a cabinet with a display screen; FIG. 10D showing multiple display stations mounted on a pedestal so that they face in differing directions; FIG. 10E showing display screens secured to the top of a table and a computer module secured centrally under the table; FIG. 10F showing one computer module and one display screen controlling several connected display screens hung on a wall; FIG. 10G showing multiple display screens each displaying different content (although not critical); FIG. 10H showing a large display screen mounted on a truck; FIG. 10I showing a parallelepiped floor mounted display station containing four to eight display screens driven by one computer; and FIG. 10J showing a compound display of several display screens each displaying part of the whole image. However, nowhere in the Gerbacia disclosure is it mentioned that four video displays would be supported in a DCD frame assembly and placed around one central flat panel television, to use the compelling and uncanny ability of a single television to attract our attention, and no matter what its content, we find ourselves looking at it and giving it our attention even if only for a short duration of time, thereby capturing a viewer's attention at the same time for the video displays in the surrounding DCD frame assembly, which generate advertising revenue. Furthermore, although FIGS. 9A, 9B, and 9C of the Gerbacia disclosure show a frame for securing a flat panel television in place that may initially look similar to the present invention DCD frame assembly, one can clearly see in FIG. 9A that there is no thin cosmetic bezel with four elongated openings through which the four elongated and rearwardly-positioned video displays are visible by a viewer of the centrally located television that can add content complementary to, or independent from, that on the central flat panel television. In contrast, in the Gerbacia disclosure one only sees a retaining plate 72 without any elongated openings in it. No system or method is known having the same structural features and advantages of the present invention.

### BRIEF SUMMARY OF THE INVENTION

The primary objective of this invention is to provide a method that uses the combination of a flat panel television and digital content display (DCD) frame assembly to provide a revenue stream from dynamic advertising that can be controlled and delivered using a digital media mind share business2business e-commerce website and the Internet, or locally controlled media content. It is also an objective of this invention to provide the combination of a flat panel television and DCD frame assembly wherein advertising on secondary digital display panels can provide a contrast to, be complementary to, and/or provide an extension of any digital media displayed on the centrally-located flat panel television. It is a further objective of this invention to provide a method of reaching a targeted demographic with content rich, high definition media via IP Multicast technology, that allows advertisers to present their products in a more focused way to audiences more likely to want to purchase their goods or services. It is also an objective of this invention to provide a method that uses the combination of a flat panel television and DCD frame assembly to provide a revenue stream from dynamic advertising that has built-in security features to protect and preserve demographic, scheduling, subscriber, and billing information. Another objective of this invention is to provide a method that uses the combination of a flat panel television and DCD frame assembly to provide a revenue stream from dynamic advertising that allows information browsing by potential subscribers and the public. It is a further objective of this invention to provide a method that uses the combination of a flat panel television and DCD frame assembly to provide a revenue stream from dynamic advertising wherein advertising revenues can be shared between the property owners where the DCD frame assemblies are located, the owners of the DCD frame assemblies, and the owners of the present invention system and method of delivering digital content to the DCD frame assemblies. Another objective of this invention is to provide a method that uses the combination of a flat panel television and DCD frame assembly to provide a revenue stream from dynamic advertising with means to validate the effectiveness thereof. It is also an objective of this invention to provide the combination of a flat panel television and DCD frame assembly that are easily mounted in place anywhere a flat panel television can be mounted. It is a further objective of this invention to provide a flat panel television and DCD frame assembly combination that have a secure means of connection to one another.

The present invention provides a method by which a dynamic message or advertisement can be displayed while integrated in a television sign and DCD frame assembly combination that comprises at least one secondary digital display panel attached to a flat panel television (LCD or plasma) or other digital display screen. The display content will be controlled via electronics in the case of digital LED screens, or with removable graphics. By utilizing digital display technology and an integrated mounting system, the present invention discloses a system and method that allows the attachment of multiple secondary digital display panels in a DCD frame assembly or enclosure that is mounted around the viewable area of a flat panel television or other digital display screen to enhance it and create additional areas for digital content delivery. The DCD frame assemblies of the present invention will be able to display dynamic, manageable content via a broadband Internet connection or locally, through an associated local network or via on-board USB, cat5 wiring, firewire-type technology or other means that allows for quick upload of local content. Furthermore, when the present invention DCD frame assemblies are used in conjunction with a flat panel television or other digital display screen in various demographic rich environments, such as but not limited to an airport or casino environment, specific targeted advertising can be carried out. By using a system that attaches to existing flat panel and digital display screen technologies, a recurring revenue stream can be created via means that have been previously unavailable. Initially a customer could purchase a present invention DCD frame assembly with a subscription, or in the alternative be given a television and present invention DCD frame assembly with the purchase of a service. The subscription or service would provide content such as advertisements, scores, weather information, etc. Revenue would be derived from advertisers who display content, and could be shared by the property owners where the DCD frame assemblies are located, the owners of the DCD frame assemblies, and the owners of the present invention system and method of delivering digital content to the DCD frame assemblies. Advertising on secondary digital displays can provide a contrast to, be complementary to, and/or provide an extension of any digital media displayed on the centrally-located flat panel television. The four secondary digital displays become the recipient of digital media content display from advertisers that has been ordered through the use of a digital media mind share business2business e-commerce website. Information browsing can also be conducted via the web front end by browsers and potential subscribers to the present invention, and advertisers and owners of property where at least one present invention digital content display frame assembly is located can also conduct information browsing via the web front end. In addition, the web front end is able to communicate through the digital media mind share business2business e-commerce website and the Internet with client authentication equipment to sign up new subscribers and also allows current subscribers access to demographic, scheduling, and billing information. Digital content display frame programming can be ordered/sent by advertisers and property owners through the Internet and the digital media mind share business2business e-commerce website to video processing and compression equipment and monitored by demographic, scheduling, and billing information equipment, and the video processing and compression equipment is able to distribute digital media content ordered by advertisers or property owners to the DCD frame assemblies located on selected properties via IP Multicast technology to reach a targeted demographic with relevant, content rich, high definition media. To further validate the effectiveness of present invention advertising, it will optionally incorporate the use of Short Message Service (SMS) text messaging technology to drive derivative value to its advertising clients. Thus, a SMS text code can be attached as needed to individual advertisements and promote an interactive environment to the viewer of the ad wherein viewers are enticed to respond directly to that ad via text message transmission, whether the interactivity is enticed by a giveaway, points, awards, etc.

The description herein provides preferred embodiments of the present invention but should not be construed as limiting its scope. Variations other than those shown and described herein, may also be incorporated into the present invention, such as but not limited to attachment of bracket bars to the housing/frame, the selection of local data input/output devices used by property owners, the type of flat panel television used, and the number of secondary digital displays associated with each flat panel television although four are most preferred. Thus, the scope of the present invention should be determined by the appended claims and their legal equivalents, rather than being limited to the examples given.

### BRIEF DESCRIPTION OF THE SEVERAL VIEWS OF THE DRAWINGS

FIG. 1 is an exploded view of the most preferred embodiment of the present invention, showing its thin cosmetic bezel, four digital content displays, and the housing/frame together that becomes a digital content display frame assembly, and also includes an on-board processor and data input/output devices that provide specific digital media content on the four secondary digital displays.

FIG. 2 is an exploded view of the most preferred embodiment of the present invention digital content display frame assembly, a flat panel television, and mounting hardware that is preferably used to secure the digital content display frame assembly around the flat panel television so that the dynamic digital content can be viewed simultaneous on both the flat panel television and the four digital content displays immediately surrounding it.

FIG. 3 is a front view of the four digital content displays in the most preferred embodiment of the present invention positioned immediately around a flat panel television to provide dynamic digital media that can be unified, in total or in part, with that displayed on the flat panel television, or be completely independent from the information being provided on the flat panel television.

FIG. 4 is an exploded view of the mounting hardware shown in FIG. 2 and the mounting pattern that could be associated with a housing/frame in preferred embodiments of the present invention and used to secure the housing/frame around the flat panel television.

FIG. 5 is a perspective view of the mounting hardware shown in FIGS. 2 and 4 and the mounting blocks that could be associated with a housing/frame in preferred embodiments of the present invention and used to secure the housing/frame around the flat panel television.

FIG. 6 is a perspective view of the mounting hardware shown in FIGS. 2, 4, and 5 and the movable mounting blocks that could be associated with a housing/frame in preferred embodiments of the present invention and used to secure the housing/frame around the flat panel television.

FIG. 7 is a schematic representation of the four present invention secondary digital displays around a flat panel television that are located on commercial property such as casino and airports and become the recipient of digital media content display from advertisers that has been ordered through the use of a digital media mind share business2business e-commerce website.

FIG. 8 is a schematic representation of the four secondary digital displays around each of four flat panel televisions that are located on commercial property such as casino and airports and become the recipient of digital media content display from advertisers that has been ordered through the use of a digital media mind share business2business e-commerce website, which also shows information browsing to be conducted via the web front end by browsers and potential subscribers, shows advertisers and owners of property where at least one present invention digital content display frame assembly is located being able to conduct information browsing via the web front end, shows the web front end able to communicate through the digital media mind share business2business e-commerce website and the Internet with client authentication equipment to sign up new subscribers and allow current subscribers access to demographic, scheduling, and billing information, shows digital content display frame programming able to be ordered/sent by advertisers and property owners through the Internet and the digital media mind share business2business e-commerce website to video processing and compression equipment and monitored by demographic, scheduling, and billing information equipment, and shows video processing and compression equipment able to distribute digital media content ordered by advertisers or property owners to the digital content display frame assemblies located on selected properties to reach a targeted demographic with content rich, high definition media.

### COMPONENT LIST

1. Thin cosmetic bezel

2. Digital content display (flat screen or flat panel)

3. Connector (provides secondary digital displays 2 with digital and electrical communication)

4. Housing/frame

5. On-board processor (provides power to digital content displays 2, controls digital content displays, and buffers and stores incoming data feeds)

6. Data input/output devices (configured for quick upload of media content)

7. Flat panel television (LCD or plasma)

8. Bracket bar

9. Mounting block

10. Upper mounting plate

11. Lower mounting plate

12. Upper latch hook

13. Lower latch

14. Fasteners

15. Latch set screw

16. Mounting pattern

17. Rail

18. Property where television 7 is located

19. Proprietary digital media mind share cloud (also referred to as ‘digital media mind share business2business e-commerce website’, and is used to manage content seen on digital content displays 2)

20. Clients/Subscribers (includes advertisers desiring display of digital media content on secondary digital displays 2 and may also include property owners who may control display content shown on television 7)

21. Web front end

22. Information browsers and potential subscribers

23. Internet

24. Digital content display frame programming

25. Client/Subscriber authentication

26. Demographics and analytics

27. Scheduling

28. Billing and payments

29. Video processing and compression

30. DCD frame assembly

### DETAILED DESCRIPTION OF THE INVENTION

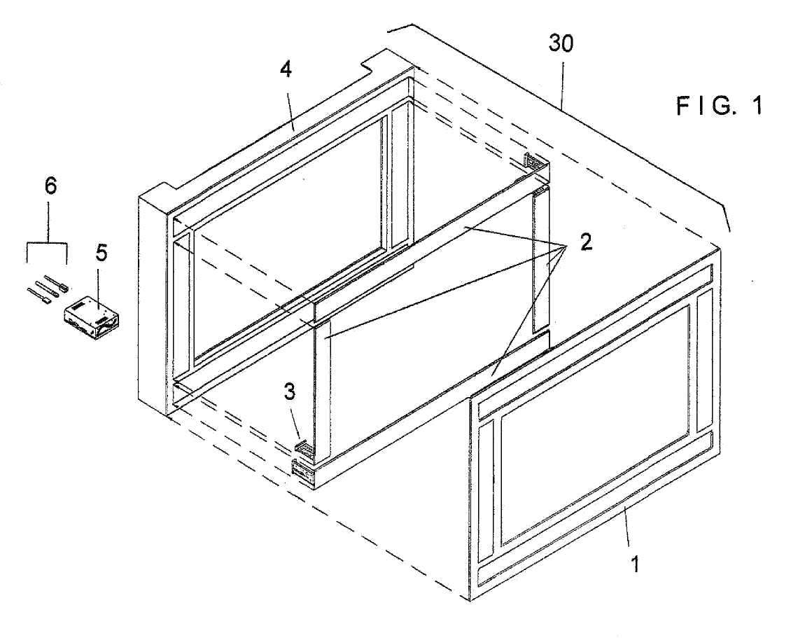

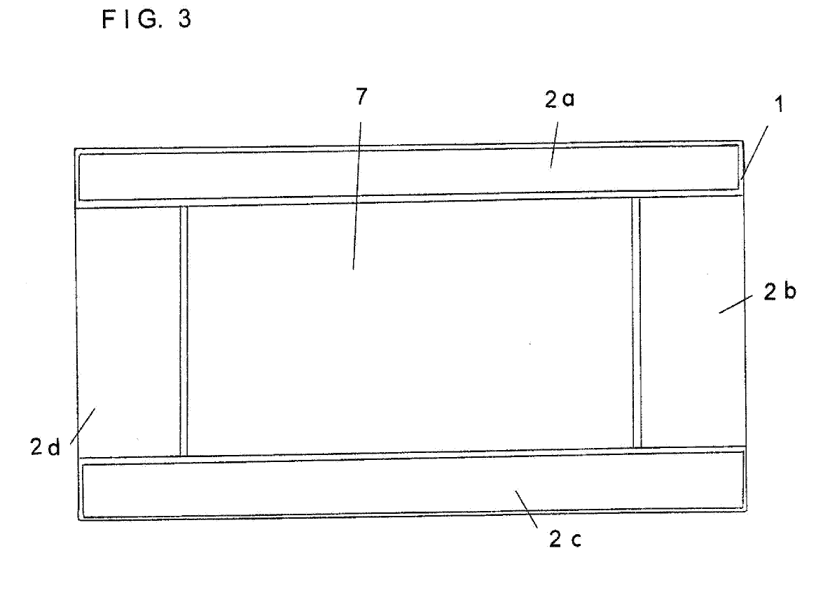

The present invention system and method will deliver a unique solution when a client has a DCD frame assembly 30 (see FIG. 1) installed surrounding a flat panel television 7 or other digital display screen. The present invention DCD frame assembly 30 will be aesthetically appealing to the eye, and will comprise multiple secondary digital display panels 2, preferably four secondary digital display panels (2a, 2b, 2c, and 2d, see FIG. 3) each smaller in total surface area than the flat screen television 7 or other digital display screen with which they become associated, but not limited thereto. The smaller secondary digital display panels 2 in the present invention DCD frame assembly 30 can be utilized for advertising specific products or services, and/or simply for their decorative appeal. One option will be to allow purchasers of present invention DCD frame assemblies 30 to subscribe to an on-line advertising Business2Business (or business-to-business) e-commerce site 19. This will allow present invention purchasers to register any of their present invention DCD frame assemblies 30 on the Business2Business e-commerce site 19 and allow other commercial enterprises and business entities an option to lease or rent the registered DCD frame assembly 30 as advertising space. Dynamic visual advertisement/programming 24 is contemplated, which can be downloaded via the Internet 23 as content from the established Business2Business e-commerce site 19. To make this process even more unique, the present invention is configured to offer its clients who participate in the service the ability to share in the advertising revenues generated. For example, if a large casino has approximately 2,000 LCD televisions 7 located on its properties 18 across the United States and it purchases 2,000 present invention DCD frame assemblies 30, a portion or all of their DCD frame assemblies 30 may be rented or leased to other businesses interested in marketing a product or service to casino patrons. Prospective advertisers wanting to lease a portion of a casino's available advertising space would then log into the Business2Business e-commerce site 19 and have access to all of casinos currently participating in the present invention shared advertising program. Although the advertiser would have to become a subscriber of the present invention system and method, due to use of e-commerce site 19 no software would burden the advertiser's computer system used to conduct present invention method steps. Once a subscriber, the advertiser would then select the location and the length of time a specific advertising campaign (advertising content/programming 24) would be run, and also select from a list of pricing options available. If less than all four digital content displays 2 around one flat panel television 7 at a specified location are purchased by a subscriber 20 for a certain time period, an identification of which digital content displays 2 out of the four typically present around a flat panel television 7 at the specified location are desired (top, left, right, and/or bottom). The present invention system could also offer prospective advertisers the necessary services to create, design, and deploy the specific advertisement desired. The present invention method includes fees for the advertising space and collects ad revenues, and then pays the owner of property 18 where the DCD frame assembly 30 is located a percentage of the advertising revenues generated by that DCD frame assembly 30. It is also contemplated for the present invention method to offer the Business2Business e-commerce site 19 based upon SaaS (Software as a Service) or “Cloud” technology and thereby eliminate the traditionally high costs of print media advertising. Because the present invention is a dynamic delivery system and method, advertisers will have the ability to change their ads quickly, easily, and often. To further validate the effectiveness of present invention advertising, it may optionally incorporate the use of Short Message Service (SMS) text messaging technology to drive derivative value to its advertising clients. Thus, a SMS text code can be attached to each individual advertisement, thereby promoting an interactive environment for the viewer 31 of the ad where viewers are enticed to respond directly to that ad, whether the interactivity enticement is for a giveaway, points, awards, etc. Cloud computing technology is preferred for use in developing and administering the Business2Business e-commerce site 19 of the present invention. Thus, subscribers 20 (property owners and prospective advertisers) of the present invention system and method will not be required to support or download any on-premise software.

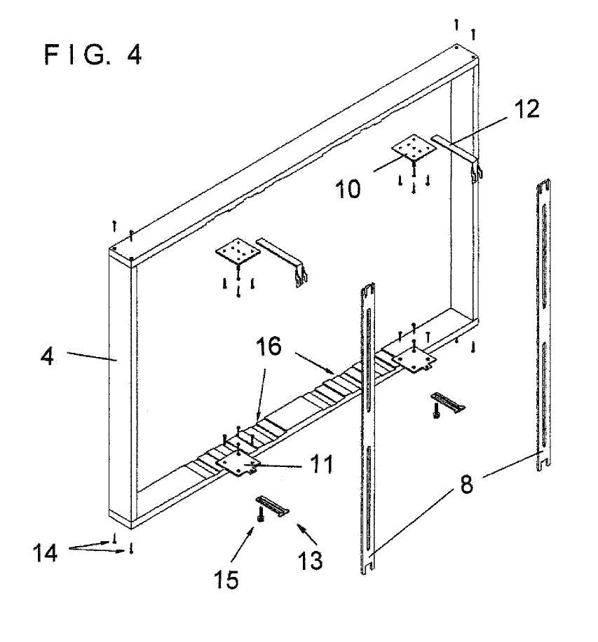

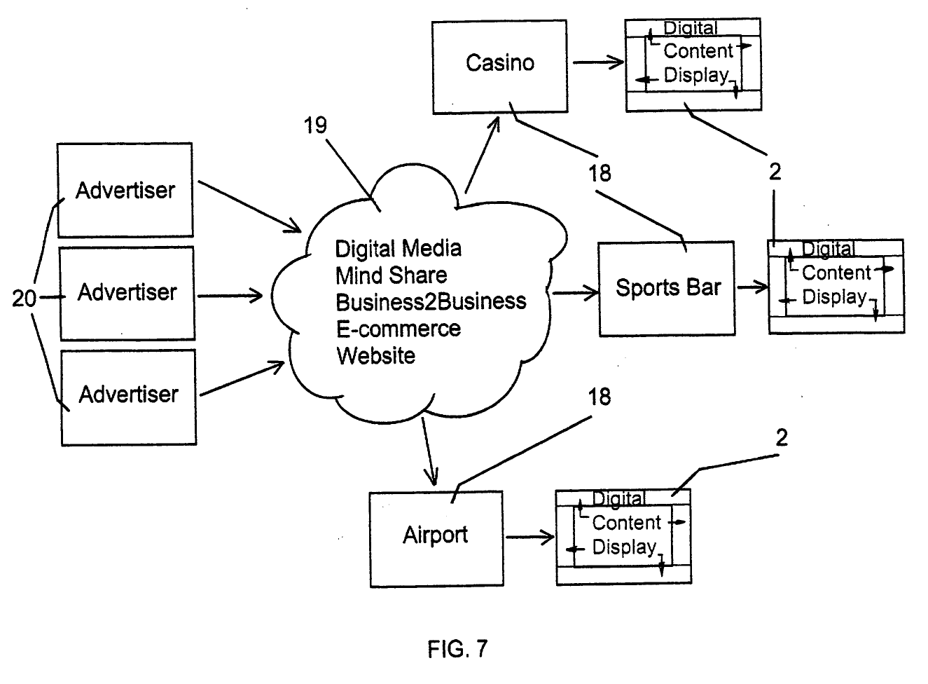

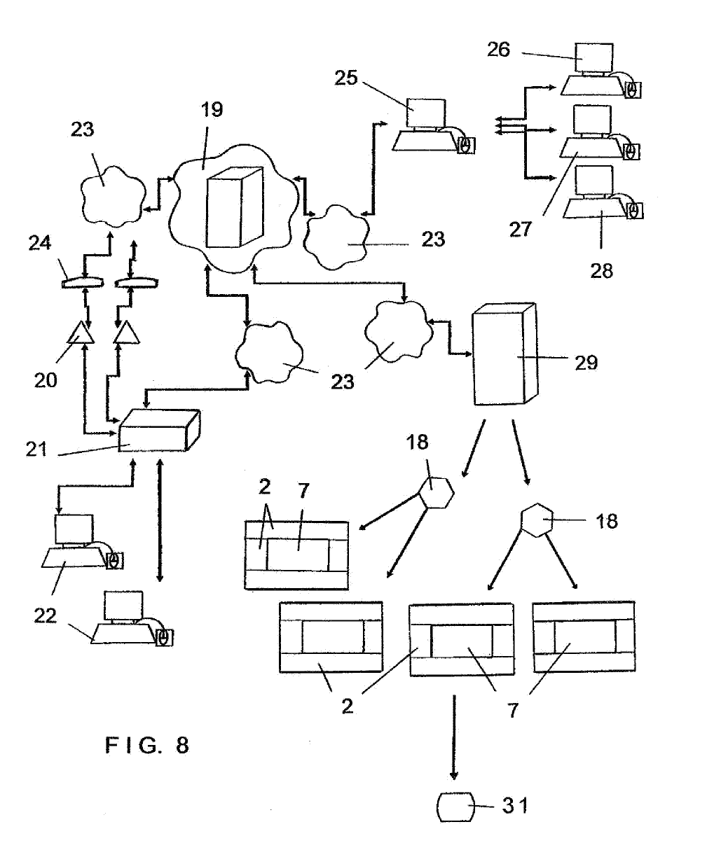

Furthermore, the present invention system and method allows the dynamic control of advertising in secondary digital display panels 2 secured in a DCD frame assembly 30 associated with a flat panel television 7. Control of the content shown on the DCD frame assembly is managed via a broadband Internet connection 23, or locally using one or more locally connected computers or computer-related devices (not shown). Via the Internet 23 control mechanism and ownership of present invention DCD frame assemblies 30, businesses can create advertisement revenue by leveraging their demographic rich environments and available flat panel television technology. Using the DCD frame assemblies 30 around flat panel televisions 7 in a demographic rich environment allows advertisers to present their products to an audience that is more likely to want to purchase their goods or services. FIGS. 1-3 show several views of the DCD frame assembly 30 and a flat panel television 7. In the alternative, FIGS. 4-6 show several ways in which the housing/frame 4 of the DCD frame assemblies 30 may be adapted for securing the bracket bars 8 employed to secure the housing/frame 4 against a flat panel television 7, so that the housing/frame 4 becomes supported by flat panel television 7. FIGS. 7 and 8 provide schematics showing how the DCD frame assembly 30 and flat panel television 7 combinations would be used for advertising and revenue generation.

FIG. 1 is an exploded view of the most preferred embodiment of the present invention DCD frame assembly 30, showing its thin cosmetic bezel 1, four secondary digital content displays 2, and the housing/frame 4 in the order of assembly (bezel 1 in front of secondary digital content displays 2, which are in front of housing/frame 4). Bezel 1 and housing/frame 4 may be made from sturdy plastic, although not limited thereto. FIG. 1 also shows an on-board processor 5 and data input/output devices 6 that provide specific digital media content on the four secondary digital displays 2. FIG. 1 further shows connectors 3 that provide digital and electrical communication to the four secondary digital displays 2. The configuration of connectors 3 is merely representative, and can be different from that shown. Also, the size and number of FIG. 1 secondary digital content displays 2 shown can be different than that identified in FIG. 1, as long as a close association between bezel 1, secondary digital content displays 2, and housing/frame 4 occurs after the installation of secondary digital content displays 2 around television 7. Furthermore, the horizontally-extending orientation of DCD frame assembly 30 in FIG. 1 should not be considered as limiting, and it is contemplated for DCD frame assembly 30 to be viewed in both portrait and landscape orientations. It should also be understood that the present invention DCD frame assembly mounts to the flat panel television 7, and does not mount to any architecture, although flat panel television 7 requires some type of mount. Furthermore, although secondary digital displays 2 appear to be interlocking with one another, and with flat panel television 7, it is bezel 1 that helps to secure secondary digital displays 2 into their positions of use, and not any interlocking engagement among adjacent secondary digital displays 2. Thus, FIG. 1 shows one means for mounting multiple secondary digital displays 2 (panels or screens) immediately around a flat panel television 7 (including LCD and plasma televisions), so that together the compelling attraction and attention-capturing power of television can be employed to allow advertisers of products and services to reach a targeted demographic with content rich, high definition media that can be seen in any location where a flat panel television 7 is, or could be, located. As shown in FIG. 1, four secondary digital displays 2 are preferably used. Digital content can be displayed on the flat panel television 7, on the multiple secondary digital displays 2 that are part of the DCD frame assembly 30 positioned for viewing immediately around the flat panel television 7, or on any combination thereof, with the DCD frame assembly 30 preferably containing four secondary digital display panels 2 in a rectangular configuration, but is not limited thereto. The content of the digital media (such as advertising/content/programming 24) viewed on the secondary digital displays 2 is mostly dynamic, and can be in contrast to the digital content displayed on the centrally-located flat panel television 7, or the content of the digital media viewed on the secondary digital displays 2 can be complementary to, unified with, and/or provide a seamless extension of, the digital content displayed on the centrally-located flat panel television 7. Furthermore, the content on the centrally-located flat panel television 7 can change at the same speed as that on the secondary digital content displays 2, or at a different rate than that on any of the secondary digital displays 2 that are a part of the same DCD frame assembly 30. Management of the digital content (such as advertising/content/programming 24) displayed on the flat panel television 7, as well as on the present invention secondary digital displays 2 immediately surrounding it, can be remotely accomplished via one or more web 19 interfaces, as well as locally accomplished via on-board USB, Cat5 wiring, firewire-type technology, or any other data input/output device 6 allowing for fast upload of local content. The housing/frame 4 upon which the present invention secondary digital displays 2 are mounted will also house any required electronics (on-board processor 5 or other) needed to satisfy the power and communication requirements of the secondary digital displays 2, and may also be attached to an independent mounting system that is adaptable to more than one make and model of flat panel television, or configured for connection to the same hardware used with independent flat panel mounting systems (such as, but not limited to, those shown in FIGS. 4-6). Once the present invention DCD frame assembly 30 is secured into its fixed position around a flat panel television 7, control cables (and/or other data input/output devices 6) are connected to the housing/frame 4 to allow relevant, content rich, high definition media to reach secondary digital content displays 2. In other words, the present invention can be considered to be a dynamic message delivery system comprising a centrally-located television sign integrated with a frame having television-like media content display capability. Thus, the present invention can be considered as a dynamic television sign and dynamic television frame combination that has built-in features allowing dynamic messaging, direct to any viewer 31 thereof. The messaging or advertising can be optionally delivered via, but is not limited to, electronic digital screens, i.e. LED, LCD and/or similar or manually-changing graphic inserts, or delivered directly to sign and/or frame silk screening, among others. It is considered that any product attaching to a television or digital display screen so as to create a television sign and television frame combination for the purposes of dynamic message delivery or advertising falls within the scope of the present invention system or method disclosed herein. For purposes of this invention a television sign and television frame combination is defined as a device attached to the exterior of a television 7 or digital display screen to change the appearance thereof without affecting the operation of the television or digital display screen, which after its installation provides the addition of secondary digital displays 2 and/or methods of dynamic message delivery (LED, LCD, graphic inserts, and the like) to the television sign and television frame combination to allow it to become an effective tool for marketing, advertising, and direct revenue generation. Applications may include, but are not limited to, use where content on the central television becomes a live video feed, slides, a movie, or a how-to-video loop; use at casinos, sporting events, musical concerts, shopping malls, car shows, airport terminals, zoos, theme parks, and other places where large groups of people congregate, to reach a targeted demographic with relevant, content rich, high definition media.

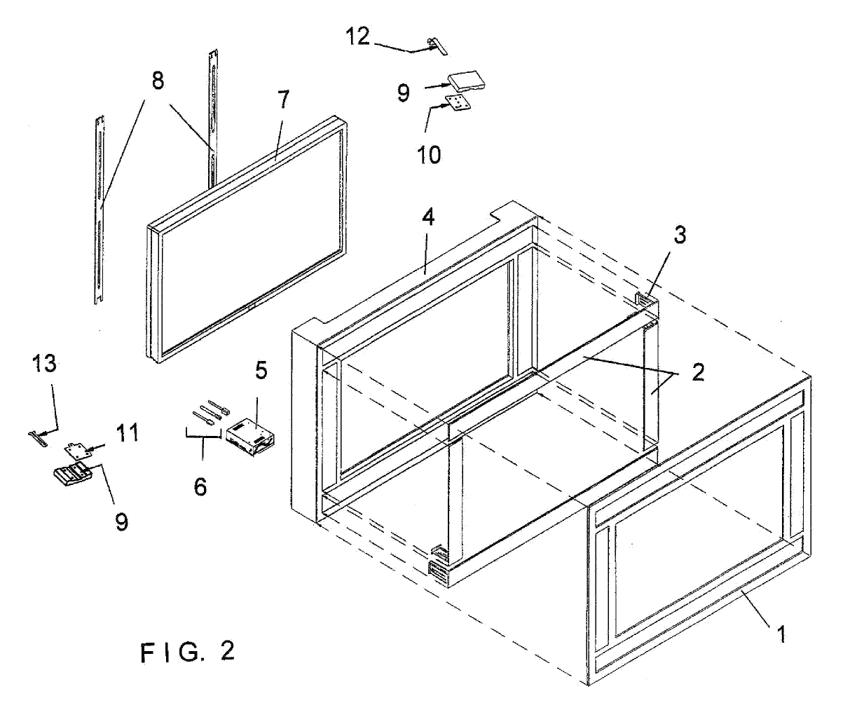

FIGS. 2 and 3 both show the DCD frame assembly 30 and a flat panel television 7, with FIG. 2 showing an unassembled condition of the most preferred embodiment of the present invention, and FIG. 3 showing it in an assembled condition. FIG. 2 is an exploded view of DCD frame assembly 30, a flat panel television 7, and mounting hardware that is preferably used to secure the DCD frame assembly 30 around the flat panel television 7 so that the dynamic digital content on both can be viewed simultaneously. Mounting hardware in the most preferred embodiment of the present invention includes two bracket bars 8, and upper end securing means that for each bracket bar 8 includes one mounting block 9, one upper latch hook 12, and one upper mounting plate 10. FIG. 2 also shows a mounting block 9, lower latch 13, and lower mounting plate 11 that are preferably used as the lower end securing means for each bracket bar 8, to secure it to housing/frame 4, or an independent frame (such as but not limited to one of those shown in FIGS. 4-6) that becomes secured to housing/frame 4. In contrast, FIG. 3 is a front view of the four secondary digital content displays 2a, 2b, 2c, and 2d in the most preferred embodiment of the present invention positioned immediately around a flat panel television 7 to provide dynamic digital media (such as advertising/content/programming 24) that can be unified, in total or in part, with that displayed on the flat panel television 7, or be completely independent from the information being provided on the flat panel television 7. The amount of bezel 1 exposed between secondary digital content displays 2 and flat panel television 7 can vary, and does not need to be limited to that shown. However, for best unified content effect across flat panel television 7 and digital content displays 2, a minimum of bezel 1 is preferred. The horizontally-extending orientation of DCD frame assembly 30 in FIGS. 2 and 3 is not a limiting feature thereof, and it is contemplated for the mounting hardware in the most preferred embodiment of the present invention to assist in securing DCD frame assembly 30 and flat panel television 7 to a wall, ceiling, or other surface for viewing in both portrait and landscape orientations.

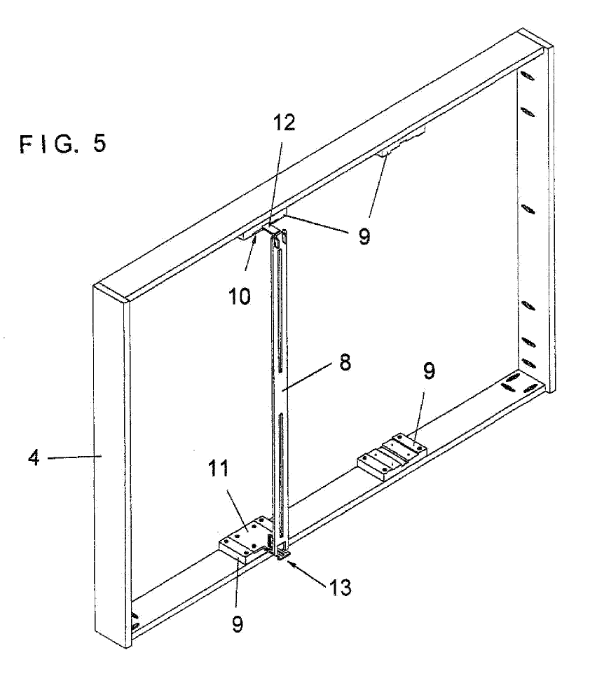

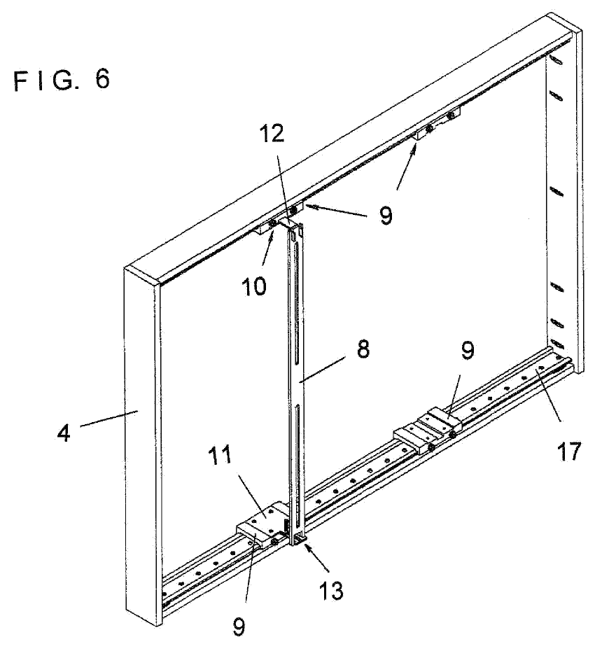

FIGS. 4-6 show several preferred but optional ways in which the housing/frame 4 of the DCD frame assembly 30 may be adapted for use in promptly securing bracket bars 8 to housing/frame 4 so that together they may become supported by an installed flat panel television 7. In the alternative, the frame 4 shown in FIGS. 4-6 could be configured as an independent piece securely connected to (or within) DCD frame assembly 30. FIG. 4 is an exploded view of the same mounting hardware shown in FIG. 2 and the mounting pattern 16 that could be associated with a housing/frame 4 in preferred embodiments of the present invention and used to secure the housing/frame 4 around a flat panel television 7. In addition, FIG. 4 shows fasteners 14 used to construct frame 4 and latch set screws 15 used to adjustably provide a tight fit of bracket bars 8 against the back of flat panel television 7. FIG. 5 is a perspective view of the same mounting hardware shown in FIGS. 2 and 4 and the mounting blocks 9 that could be associated with a housing/frame 4 in preferred embodiments of the present invention and used to secure the housing/frame 4 around the flat panel television 7 in place of mounting pattern 16. FIG. 6 is a perspective view of the mounting hardware shown in FIGS. 2, 4, and 5 and the movable mounting blocks 9 that could be associated with a housing/frame 4 in preferred embodiments of the present invention and used to secure the housing/frame 4 around a flat panel television 7. Mounting pattern 16, mounting blocks 9 (movable and fixed), and rails 17 provide a means for securely attaching DCD frame assembly 30 to a wide variety of flat panel televisions 7 made by different manufacturers.

FIGS. 7 and 8 provide schematics showing how the DCD frame assembly 30 and flat panel television 7 combinations would be used for advertising and revenue generation. FIG. 7 is a schematic representation of the four present invention secondary digital displays 2 around a flat panel television 7 that are located on commercial property 18 (such as casino and airports) and become the recipient of digital media content (such as advertising content/programming 24) from subscribing advertisers 20 that has been ordered through the use of a digital media mind share business2business e-commerce site 19. Thus, when a person or business having at least one flat panel television 7, or a person wanting to locate a flat panel television 7 in a place where large groups of people congregate, buys a DCD frame assembly 30 for the flat panel television 7, the present invention system and method can be used to generate revenue from that DCD frame assembly 30, which is then shared between the owners of the property 18 where the DCD frame assemblies 30 are located, the owners of the DCD frame assemblies 30 (not necessarily the same entity as the property owner), and the owners of the present invention system and method of delivering digital content to the DCD frame assemblies 30.

FIG. 8 is a schematic representation of the four secondary digital displays 2 preferably around each of four flat panel televisions 7 that are located on commercial property 18 such as a casino, airport terminal, wildlife park, theme park, sporting event, shopping mall, auto show, or musical concert, and become the recipient of selected digital media content/programming 24 from advertisers 20 that has been ordered through the use of a digital media mind share business2business e-commerce site 19. In the lower right quadrant of FIG. 8, one can see video processing and compression equipment 29 forwarding advertising content/programming 24 to property 18, which then sends the advertising content/programming 24 to the individual secondary digital content displays 2 that are scheduled to receive it. It is preferred that IP Multicast technology be used for sending the advertising content/programming 24 to the properties 18, so that the advertisers do not have to be burdened by any software importation onto their computers. Thereafter, National Television System Committee (NTSC) communication, such as but not limited to cat5 can be used to send the advertising content/programming 24 from the property 18 to each secondary digital content display 2 scheduled to receive it. Flat panel television 7 may also receive advertising content/programming 24, or in the alternative it may display live-feed television programming, slides, a movie, how-to programming, and or other local data input. It is also preferred for the video processing and compression equipment 29 to communicate with the digital media mind share business2business e-commerce site 19 using Secure Sockets Layer (SSL) encryption protocols. Furthermore, below the secondary digital content displays 2 in the lower right quadrant of FIG. 8, a viewer 31 is shown with an arrow directed from secondary digital content displays 2 toward viewer 31 that represents the receipt of a Short Message Service (SMS) text messaging code or other information that can assist in validating the effectiveness of advertising content/programming 24. Thus, each individual advertisement content/programming 24 can optionally promote an interactive environment with the viewer 31 of the ad wherein the viewer is enticed to respond directly to that ad, whether the interactivity is enticed by a giveaway, points, awards, etc. Also, particularly when SMS technology is used, derivative value can be obtained for advertising clients 20 in the form of revenue generated by the responsive text messaging. In the lower left quadrant of FIG. 8, one sees two computer outlines 22 that represent browsers and potential subscribers 22 having the capability of conducting information searches about the present invention system and method using the web ‘front end’ 21 of business2business e-commerce site 19 (also referred to herein simply as web front end 21), shows advertisers 20 and owners of property 18 where at least one present invention DCD frame assembly 30 is located able to conduct information browsing via the web front end 21, shows the web front end 21 able to communicate through the digital media mind share business2business e-commerce site 19 and the Internet 23 with client authentication equipment 25 to sign up new subscribers 20 and allow current subscribers 20 access to demographic 26, scheduling 27, and billing information 28, shows digital content display frame programming 24 able to be ordered/sent by advertisers 20 and property 18 owners through the Internet 23 and the digital media mind share business2business e-commerce site 19 to video processing and compression equipment 29 and monitored by demographic 26, scheduling 27, and billing information 28 equipment, and shows video processing and compression equipment 29 able to distribute digital media/advertising content 24 ordered by advertisers 20 or property 18 owners to the DCD frame assemblies 30 located on selected properties 18 to reach a targeted demographic with relevant, content rich, high definition media. Remembering that it is the compelling and attention-capturing power of television (including flat panel television 7 of the present invention), with its uncanny ability to draw people's attention and hold it, that causes viewers to also look at dynamic advertisement content/programming 24 displayed immediately around the flat panel television 7 in the same field of view.

We claim:

1. A digital content display frame assembly that takes advantage of the compelling and attention-capturing power of television to attract and hold the attention of a targeted demographic so that when advertising content is placed in close proximity to the television, at least a portion of a viewer's attention becomes directed toward the advertising content, said digital content display frame assembly comprising:
a frame housing configured to be fixedly positioned in front of a flat panel television and allow unobstructed viewing of content displayed on said flat panel television;
mounting means adapted for connection to said frame housing and fixedly securing said frame housing to a flat panel television so that support for said frame housing and said mounting means is provided by the flat panel television;
a plurality of digital content displays sized and configured to be positioned in front of said frame housing in a collective configuration that provides a border around a flat panel television associated with said frame housing while allowing unobstructed viewing of content displayed on said flat panel television, each of said digital content displays in fixed association with said frame housing, each said digital content displays also having at least one connector associated therewith that is configured for providing said digital content display with digital and electrical communication;
on-board processor means adapted for providing power to said digital content displays, buffering and storing content to be shown on said digital content displays, and timely delivery of content to said digital content displays; and
at least one data input and output device associated with said housing that is configured and positioned to communicate with said on-board processor means, wherein when content is provided via said at least one data input and output device to said on-board processor means, and said on-board processor means causes content to shown on any of said digital content displays, and a flat panel television also associated with said frame housing is also activated, the attention-capturing power of the flat panel television will cause at least a portion of a viewer's attention to become directed toward the content shown on said digital content displays providing a border around the flat panel television.

2. The digital content display frame assembly of claim 1 further comprising a bezel configured for positioning in front of said digital content displays and said frame housing, said bezel also configured to assist in maintaining a secure and fixed relation between said digital content displays and said frame housing;

3. The digital content display frame assembly of claim 1 wherein said on-board processor means is further adapted to deliver independent content to each of said digital content displays associated with said frame housing that is also independent from content displayed on a television associated with said frame housing, to deliver content to at least one of said digital content displays that provides a unified presentation with content displayed on a television associated with said frame housing, and to deliver content to at least one of said digital content displays that provides a unified presentation with content displayed on a television associated with said frame housing and also with content shown on at least one other of said digital content displays.

4. The digital content display frame assembly of claim 1 wherein said mounting means is also adapted for prompt, easy, and repeat installation of said frame housing on a flat panel television, and prompt, easy, and repeat removal of said frame housing from a flat panel television.

5. A method for using the digital content display frame assembly of claim 1, said method comprising the steps of:
providing said digital content display frame assembly of claim 1, content intended for viewing on at least one of said digital content displays, and an installed flat panel television;
using said mounting means to fixedly secure said frame housing with said digital content displays and said bezel to said flat panel television so that support for said frame housing and said mounting means is provided by said flat panel television, and further so that said frame housing is positioned in front of said flat panel television and allows unobstructed viewing of content displayed on said flat panel television; and
providing said content intended for viewing on at least one of said digital content displays to said on-board processor means via said at least one data input and output device; and
said on-board processor means delivering said content to at least one of said digital content displays.
at least one data input and output device associated with said housing that is configured and positioned to communicate with said on-board processor means, wherein when content is provided via said at least one data input and output device to said on-board processor means, and said on-board processor means causes content to shown on any of said digital content displays, and a flat panel television also associated with said frame housing is also activated, the attention-capturing power of the flat panel television will cause at least a portion of a viewer's attention to become directed toward the content shown on said digital content displays providing a border around the flat panel television.

6. The method of claim 5 further wherein said content comprises advertising, and said installed flat panel television is located in a high traffic area viewable by a targeted demographic.

7. The method of claim 6 wherein said advertising content further comprises a means of soliciting an interactive response from its viewers that is adapted to validate the effectiveness of said advertising content.

8. The method of claim 7 wherein said means of soliciting an interactive response from viewers of said advertising content is further adapted with text messaging technology.

9. The method of claim 6 further comprising a plurality of said installed flat panel televisions and a digital content display frame assembly of claim 1 associated with each said flat panel television, said method also comprising the step of providing a digital media mind share e-commerce website configured to receive, store, and forward said advertising content, the step of providing scheduling means adapted for arranging time and duration of display for said advertising content on various ones of said digital content displays, and the step of using said digital media mind share e-commerce website to forward said advertising content to various ones of said digital content displays at times and for durations identified by said scheduling means.

10. The method of claim 9 further comprising the step of providing at least one revenue generating advertiser and an Internet connection, the steps of said advertiser selecting said advertising content and forwarding said advertising content to said digital media mind share e-commerce website via said Internet connection, and the step of said advertiser also using said scheduling means to select a time and duration of display for said advertising content on various ones of said digital content displays.

11. The method of claim 10 wherein owners of said digital media mind share e-commerce website and owners of said installed flat panel televisions share revenue generated by said at least one advertiser.

12. The method of claim 9 further comprising the step of providing billing means adapted for identifying fees associated with display of said advertising content on said digital content displays and the step of using said billing means to generate revenue from said at least one revenue generating advertiser.

13. The method of claim 9 further comprising the step of providing demographic and analytic means adapted at a minimum for identifying demographic and analytic information associated with said installed televisions and the step of using said demographic and analytic means for the benefit of said at least one revenue generating advertiser.

14. The method of claim 9 further comprising the step of providing client authentication means adapted for recognizing said at least one revenue generating advertiser and allowing said at least one revenue generating advertiser access to said scheduling means, and the step of using said client authentication means to prevent access of non-advertisers to said scheduling means.

15. The method of claim 9 further comprising the step of providing a web front end configured to allow non-secure information browsing about said method, and the step of using said web front end to allow non-secure information browsing about said method and said digital content display frame assemblies by potential revenue generating advertisers and owners of installed flat panel televisions.

16. The method of claim 9 further comprising the step of providing video processing and compression equipment and Internet Protocol multicasting technology, and the step of using said video processing and compression equipment and said Internet Protocol multicasting technology to forward said advertising content from said digital media mind share e-commerce website to said installed televisions.

17. The method of claim 9 further comprising the step of providing a web front end configured to allow non-secure information browsing about said method, the step of using said web front end to allow non-secure information browsing about said method and said digital content display frame assemblies by potential revenue generating advertisers and owners of installed flat panel televisions, the step of providing billing means adapted for identifying fees associated with display of said advertising content on said digital content displays, the step of using said billing means to generate revenue from said at least one revenue generating advertiser, the step of providing at least one revenue generating advertiser and an Internet connection, the steps of said advertiser selecting said advertising content and forwarding said advertising content to said digital media mind share e-commerce website via said Internet connection, the step of said advertiser also using said scheduling means to select a time and duration of display for said advertising content on various ones of said digital content displays, and the step wherein after advertising revenue is generated owners of said digital media mind share e-commerce website and owners of said installed flat panel televisions share said advertising revenue.

18. The method of claim 17 further comprising the step of providing video processing and compression equipment and Internet Protocol multicasting technology, and the step of using said video processing and compression equipment and said Internet Protocol multicasting technology to forward said advertising content from said digital media mind share e-commerce website to said installed televisions.

19. The method of claim 18 further comprising the step of providing encrypted communication, the step of using said encrypted communication between said digital media mind share e-commerce website and said video processing and compression equipment, and the step of using said encrypted communication between said digital media mind share e-commerce website and said client authentication

20. The method of claim 17 further comprising the step of providing demographic and analytic means adapted at a minimum for identifying demographic and analytic information associated with said installed televisions, the step of providing client authentication means adapted for recognizing said at least one revenue generating advertiser and allowing said at least one revenue generating advertiser access to said scheduling means, said billing means, and said demographic and analytic means, the step of using said demographic and analytic means for the benefit of said at least one revenue generating advertiser, and the step of using said client authentication means to prevent access of non-advertisers to said scheduling means, said billing means, and said demographic and analytic means.
